(19) United States
(12) Patent Application Publication
(10) Pub. No.: US 2011/0206242 A1
(43) Pub. Date: Aug. 25, 2011

(54) Instrumental Support for Monitoring the Color Imprint in the Manufacture of Surfaces Patterned in Multiple Colors

(75) Inventors: Robert Massen, Oehningen (DE); Joerg Eberhardt, Silbratshaus (DE)

(73) Assignee: BAUMER INSPECTION GMBH, DE-78467 Konstanz (DE)

(21) Appl. No.: 12/999,384

(22) PCT Filed: Jul. 6, 2009
(86) PCT No.: PCT/EP09/04860

§ 371 Date: May 6, 2011

(30) Foreign Application Priority Data
Jul. 6, 2008 (DE) 10 2008 031 459.5

(51) Int. Cl. G06K 9/00

(52) U.S. Cl. 382/112

(57) ABSTRACT

A method is disclosed that relates to maintaining or improving the end quality of the visual color imprint of multiple-colored patterned surfaces. These surfaces cannot be measured using the decorations that are manufactured by printing processes, the so-called primary decoration, because subsequent processes change the color imprint further resulting in the so-called secondary color imprint. According to the invention, prediction rules are determined based on samples from the primary and secondary decorations during a learning phase to establish from n-channel images of samples of the primary decoration color imprint characteristics and convert those to such characteristics for the secondary decoration; and/or to establish from n-channel images of samples of the primary decoration images of the secondary decoration and to calculate color imprint characteristics. Color imprint characteristics are extracted and converted with the aid of the prediction rules to the color imprint characteristics of the secondary decoration, and applied.

### FIELD OF THE INVENTION

The present invention relates to a method and an apparatus for predicting the changes of a primary color imprint of a decorated surface.

### BACKGROUND OF THE INVENTION

The manufacture of esthetic surfaces having narrowly defined quality tolerances of the visual color imprint is not only a classical problem in the high-end printing of books, magazines and packing materials that has only inadequately been resolved from a technical viewpoint; but it is also an equally significant economic problem considering the many large quantities of decorated surfaces that are encountered in the furniture and flooring industries as well as inside and outside paneling and casing applications for buildings, which are primarily produced by printing processes.

As described previously in EP 1 642 098 B1 “Method and apparatus for the metrological detection of the differences in the visually perceived color imprint between a multiple-color patterned reference and a multiple-color patterned surface of a work piece,” classical calorimetry that is limited to measurement and comparison of single-color areas is principally unable to emulate with metrological means the visual perception of the human visual system for areas that are patterned in multiple colors.

In particular, the influence of the spectral band width relative to color perception when viewing such surfaces is currently neither modeled by the traditional colorimetry and its traditional instruments, such as the photospectrometer and colorimeter, nor by the newer instrumentalities as proposed in the CIECAM standards, the so-called “Color Appearance Models” see e.g. M. Fairchild: Color Appearance Models, 2nd edition, 2005, John Wiley & Sons Ltd).

The aforementioned EP 1 642 098 B1 teaches a new method and a new apparatus for implementing the method that emulates the special characteristics of the human system of sight of being able to perceive slight changes in the definition of the image (=of the spatial frequency band width) as a shift of the color hue by a color camera apparatus and computer-supported image processing. EP 1 642 098 B1 teaches to describe the deviation of the visual color imprint of multiple-color patterned areas from a reference area in such a way that n-channel color statistics (n-channel color histograms) and/or characteristic numbers derived therefrom, such as mean values, variances, etc., and the global image definition (spatial frequency band width) are detected and displayed simultaneously, utilizing the aid of imaging sensors with color scanning (color cameras, imaging spectrometer, etc.), as well as a corresponding evaluation of the n-channel color images generated by these image donors.

This allows for continuous checking action of the constancy of the perceived color imprint of the produced decorated surface during routine production, for representing any deviations in comparison with the reference and for notifying the printer regarding any causative processes (color pigments, registration). The printer is thereby given valuable in-line instrumentation for substantially better adjusted decorating processes and for maintaining the constancy of any adjustments once made.

Many surfaces, such as on furniture, floors, etc., are traditionally decorated by a press-on process or lamination with printed or melamine-impregnated decorative papering, or by the application of printed thermoplastic decorative sheeting. Newer printing techniques, such as e.g. so-called direct printing (also referred to as analog printing) and ink-jet printing (also referred to as digital printing) are able to print a carefully pre-treated panel directly, thereby foregoing any use of decorative papers or sheeting.

For all of these decorative processes it is very important to have immediate monitoring of the decorative printing process in order to detect any instabilities early and still during the start-up adjustment phase of a new order; this can be achieved with the methods and apparatuses according to the teaching of EP 1 642 098 B1. However, this monitoring action is an inspection of the preliminary color imprint, as it is available immediately after the printing process. But this imprint, which will subsequently be referred to as “primary color imprint,” still differs significantly from the color imprint of the finished decorated product and/or the product after it has undergone further processing steps. This changed color imprint will be referred to as the “secondary color imprint” in the following:
a) the primary color imprint of, for example, a decorative paper changes considerably after going through the printing line consequent to the then-following process steps, including impregnation and pressure- and temperature-specific pressing processes with the substrate (fiberboard, etc.), 3D texturing by embossed patterns, etc.;
b) the primary color imprint that was applied to a panel decorated by direct (analog) print often changes during the further course due to the process steps that follow and that provide for the application of protective layers (frequently with corundum-mixed UV-cured coatings).

Subsequently, the produced decoration after the first production step, which is normally the actual printing process, will be referred to as the “primary decoration;” the decoration after the considered further process steps to an intermediate product or final product will be referred to as the “secondary decoration.”

The teaching of EP 1 642 098 B1 is only able to deliver information regarding the stability of the primary color imprint during a certain product application and/or in comparison to the color imprint of primary decorative references (non-impregnated decorating paper samples, non-protectively coated directly printed panels, etc.).

But this does not provide the printer with information as to what extent the secondary color imprint, which is relevant for the final product quality or after further process steps, will deviate from the (secondary) references that have been prescribed by the customer. It is therefore still necessary for the printer to take, for example, primary decoration paper samples during the printing application, to impregnate the samples in the testing lab and press them together with a fiberboard sample, allow the construct to cool and then subject these secondary decoration paper samples to a visual comparison with the secondary “golden references” (=the customer-approved secondary decoration samples).

This process is time-consuming (ca. 30-45 minutes); often routine production is stopped until the results of the visual comparison are available. During the adjustment phase in preparation of a new printing order, moreover, this cumbersome process must under certain circumstances perhaps be carried out repeatedly until the so-called “color matching” process is complete and the print order can be started.

The required process is similarly cumbersome for analog and digital decorative printing. It is imperative that the printer wait for the coating process steps that follow the printing step in order to obtain a routine sample that can be compared in terms of the color imprint with the reference as provided by the customer.

Another problem involved in connection with these directly printed panels are high material losses with regard to the decorative paper and which occur when whole panels must be sorted out because the secondary color imprint does not match; this means these new technologies come with even higher economic pressure for creating (secondary) decorations with a correct (secondary) color imprint than in the case of the cheaper decorative papers.

In summary, we can state that, on the one hand, providing for instrument-based monitoring of the printing process in decorative applications of surfaces patterned in multiple colors according to EP 1 642 098 B1 is already a great assistive tool for the printer in order to produce decorations having consistent, preset primary color imprints. But, on the other hand, it is not possible to compare deviations in the primary color imprint directly with the tolerances that the customer requires for the secondary color imprint. Upon detecting drifting in the context of the primary color imprint, the printer is therefore not able to evaluate these deviations correctly. The printer is unable to discern if such drifting will result in secondary color deviations that may fall within the allowable tolerances for the secondary color imprint or that will fall outside of the allowable tolerances of the secondary color imprint. Consequently, too often it is the case that corrective action is taken when it is not necessary, thereby wasting valuable productive printing time; or corrective action is not taken in a timely manner, thereby creating the risk that large quantities of decorative products are produced that will not match the prescribed requirements for the secondary color imprint.

Also during the adjustment phase of a new decoration, the so-called color matching phase, the printer is unable to utilize the according to EP 1 642 098 B1 measureable deviations of the primary color imprint in order to adjust the decorative process with as much focus as possible in order to ensure that the determinative secondary color print will be within the tolerances as preset by the customer.

### SUMMARY OF THE INVENTION

Therefore, it would be of great economic and technical utility to have a method and an apparatus for implementing the method that would be able to predict (technical jargon borrowed from signal processing: “to predict”) the changes of the primary color imprint of a decorated surface possibly occurring after the printing action due to surface treatments, such as impregnation and pressing to a substrate, applied protective coatings, incorporation of an abrasion-resistant agent, etc., to apply those to the measurable primary color imprints that have not yet been surface-treated and to thereby detect and evaluate later deviations from the desired secondary color imprint early.

A predictive method of this kind, applied directly to the decoration process, such as decorative paper and decorative sheeting printing processes, analog or digital direct printing, preferably to the measurable parameters that describe the primary color imprint in the production line, would be able to inform the printer directly as to whether the routine production is still within the tolerances of the secondary color imprint, thus precluding the need for the time-consuming production of laboratory-made impregnations and press-on actions for the manufacture of the secondary decorative samples.

A prediction method of this kind could provide, if directly applied to the decoration process, such as decorative paper or decorative sheeting print, analog or digital direct print, preferably inside the production line, purely mathematically calculated scan-able images based on the primary decoration in order to predict the images of the secondary decoration that are not physically in existence yet and to inform the printer directly as to whether the routine production is still within the tolerances set for the secondary color imprint.

Such a prediction process would also mean a considerable acceleration of the color matching process, i.e. the adjustment of the required primary color imprints upon start-up of a new printing order for the generation of a desired secondary color imprint, because during the adjustment process of the printing devices, based on the color images that are recorded in the line, the pre-calculated characteristics that determine the secondary color imprint are continually displayed, such as the predicted color statistics and the predicted image definition, whereby they guide the printer and thereby the adjustment of the primary decoration.

A prediction of this kind would thus constitute a substantial increase of the productivity of the decorative processes, ranging from the printing of the decorative paper or sheeting to the direct analog or digital printing processes, and this would help avoid producing waste due to spoiled printed sheets thus improving the ecological balance of a green decorative printing operation.

This object of monitoring, in particular inside the production line, the quality of the visual color imprint of products having surfaces patterned in multiple colors using imaging sensors, and wherein these products undergo further process steps after the primary decoration that also influence the process steps until the availability of the secondary decoration, is achieved according to the invention by providing for two multiple-level method steps; and herein it applies that
a) in a first multiple-level process step, suitable samples are detected by an imaging sensor as a reference for the primary decoration and the secondary decoration resulting therefrom; and the image signals are transmitted to a computing device; and based on the image signals, the computing device and the image processing method determine characteristics for describing the color imprint of the decoration of the samples; and the comparison of the values of the characteristics for the description of the color imprint of the primary decoration and the values of the characteristics for the corresponding description of the color imprint of the secondary decoration yield prediction rules that transfer as precisely as possible the values of the characteristics for the description of the color imprint of the primary decoration to those for the description of the secondary decoration; and these prediction rules are stored under the corresponding product in a database;
   (Learning phase for establishing the direct prediction rules)
b) in a second method step during the production of a certain decoration, based on the images of the primary decoration and recorded by the at least one imaging sensor and transmitted to the computing device, the same characteristics are determined and used as during the learning phase for the description of the visual color imprint of the primary decoration; and they are converted using the prediction rules stored for this decoration in the database into the corresponding characteristics for the description of the color imprint of the secondary decoration; and in order to control and regulate the technical process of the primary decoration, the predicted values are displayed numerically and/or graphically, and/or they are compared with the prescribed tolerances for the secondary decoration;
   (Testing phase to check the production of the primary decoration with direct prediction)

The indirect path is identical in meaning with the direct prediction of color imprint characteristics of the secondary decoration as derived from color imprint characteristics of the primary decoration in that it provides that first the secondary decorative images are derived from the scanned images of the primary decoration by a prediction that is based on the scanned images in order to subsequently calculate the characteristics of the color imprint based on these images of the secondary decoration and to display them numerically and/or graphically and compare them with the tolerance values. In the following, we will refer to this method as the “indirect prediction.” The essential difference between direct and the indicted predictions lies in the fact that with regard to the direct prediction, the prediction rules calculate characteristics of the color imprint of the secondary decoration based on the characteristics of the primary decoration; while with regard to the method of the indirect prediction, the prediction rules calculate secondary decoration images based on the primary decoration images and that, based on these predicted images, the characteristics for the description for the color imprint of the secondary decoration are calculated, displayed and compared with the tolerances that are valid for the secondary decoration.

The method according to the invention will be explained in an exemplary manner, but thereby not in any way limiting its scope, on the basis of the production of (primary) decorative papers for floor laminates with color patterns using a classical multiple-color printing process followed by impregnation and pressing to a fiberboard substrate arriving at a secondary decoration. For reasons of simplification, the direct prediction of the color imprint characteristics of the secondary decoration will be represented based on the color imprint characteristics of the primary decoration. The alternative option of an indirect prediction is obvious for the person skilled in the art of image processing and does not require any further explanation.

### BRIEF DESCRIPTION OF THE DRAWINGS

The following will refer to these figures:

FIG. 1 shows, by way of an introduction to improve general understanding, the process chain of the production of floor laminates -17-, essentially comprised of a fiberboard -16- upon which are pressed, applying high pressure and temperature, a melamine-impregnated decorative paper -11-; i.e., pressed on by way of a multiple-color gravure printing process -12- using a short-cycle or continuous press -15-; as well as the two process levels that are necessary for checking the visual color imprint: decorative paper print (primary decoration) -13- and pressed-on melamine-impregnated decoration (secondary decoration) -18-;

FIG. 2 illustrates, using the example of a 3-dimensional RGB color histogram -21-, the change of the 3-dimensional color histogram -23- of the primary decoration -17- in the corresponding 3-dimensional color histogram -22- of the secondary decoration -13- by the process steps following the multiple-color print of the primary decorative paper, which are impregnation with melamine and press-on action. This change can be mathematically described by the transformation T[PDH(r,g,b)];

FIG. 3 clarifies the continuous graphic display -31- of the stability of the color imprint of the primary decoration ΔCPrimaryDecor, plotted over the produced length of the merchandise line -32-, and the stability of the predicted color imprint of the secondary decoration ΔCSecondaryDecor relative to the faded in tolerances -33- by way of the transformation T[PDH(r,g,b)] that must be observed for the secondary decoration. ΔC is, by way of an example, a simple scalar characteristic for the description of the change of the color imprint; i.e., the length of the displacement vector between the focus points of the color histograms of the primary decoration and the secondary decoration.

### DETAILED DESCRIPTION

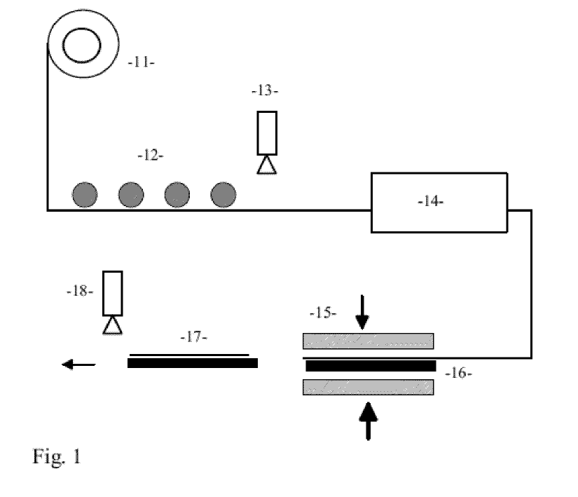

As shown schematically in FIG. 1, the production of decorative paper starts with the unprinted role of specialty paper -11- that is normally printed by a multiple-color gravure printing process -12-. After its completion, this primary decorative paper can be inspected by color cameras -13- directly inside the production line or visually by the printer using samples taken from the product in order to arrive at an initial statement regarding the primary color imprint.

The teaching of EP 1 642 098 B1 describes by way of an example a method according to the state of the art for the instrument-supported, metrological detection of the visual primary color imprint with the aid of color cameras for which the combined evaluation of n-dimensional color statistics and/or their characteristic numbers and the definition of the image of the primary decoration are continually measured.

In the now following impregnation -14- step, using melamine-containing resins the decorative paper is prepared for the pressing action. The impregnated decorating paper is pressed to the actual substrate material -16-, which is usually a fiberboard, by a continuous or short-cycle press -15- and applying high temperatures and pressures.

These large-scale technical processes involving impregnation and thermal pressing are usually not color-neutral; i.e. they may substantially change the color imprint of the primary decoration. Thus, only at the conclusion of the pressing action is it possible to visually inspect by way of a camera the secondary color imprint -17- of the pressed, decorated laminate that is of crucial importance to the end customer, which is when it is possible to assess the final esthetic quality.

These changes that occur after the primary multiple-color printing process cannot be described by rules at the current time, which means it is always necessary and required by the end customer that the printer undertake frequent visual controls during the production of an order, specifically by using manually extracted samples of the primary decoration paper and pressing them, using a miniature laboratory impregnation facility and a small laboratory-scale press facility, into a laminate sample that is subsequently compared with the customer-approved reference samples.

This laboratory-type emulation of the large-scale technical process “impregnation+pressing” is very time-consuming, causes frequent down-times of the decorating print facility and thereby considerably reduces the productivity of the entire printing line.

The idea of the invention teaches that the changes of the visual color imprint between the primary decoration -13- and the secondary decoration -17- are predicted by the prediction rules that, if applied to images of the primary decoration as early as at the observation location -13-, i.e. directly inside the printing process, and inform the printer regarding the deviations of the visual color imprint that must be expected in the end product, the secondary decoration, giving the printer thereby the opportunity to initiate and evaluate suitably targeted counter-acting measures immediately without the time-consuming process of laboratory-based impregnation and pressing.

The method according to the invention presupposes generally that the processes following the primary print, in the example this is the impregnation and the pressing, are sufficiently stable to allow for establishing sufficiently stable prediction rules based on a small number of samples of the primary and secondary decorations.

But the idea of the invention also addresses the determination and the application of prediction rules that are not only specific for a certain decoration but also for a certain adjustment of the processes following the printing, for example relative to certain melamine formulations, certain pressure/temperature/time settings of the press, etc.

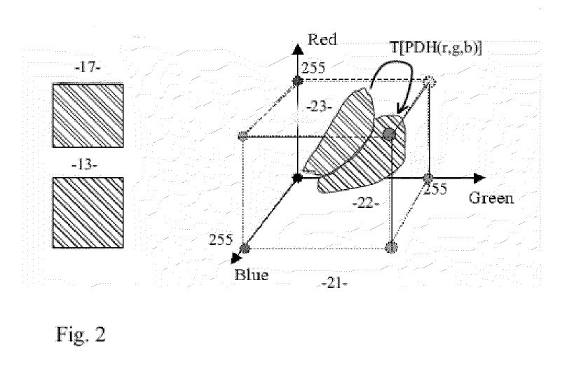

The change of the color imprint due to impregnation and pressing of decorative paper is explained in an exemplary manner in FIG. 2 using an individual important characteristic that describes the visual color imprint of areas patterned in multiple colors, i.e. the 3-dimensional color statistic (3-dimensional color histogram in RGB color).

According to the invention, in practical applications several of such characteristics are used to describe the color imprint; for example, EP 1 642 098 B1 teaches color statistics and image definition. A limitation to one characteristic in the context of the present description was chosen to simplify the representation of the inventive idea.

As shown in FIG. 2, a primary decoration sample -13- and the associated secondary decoration sample -17- are recorded with a 3-channel image donor; e.g., an RGB color camera. These recordings can occur inside the production line by correspondingly calibrated color cameras at the measurement locations -13- and -17-; but also possible is the taking of samples using an external image donor; e.g., an RGB flatbed scanner.

At least one color image of the primary decoration -13- and the secondary decoration -17- are transferred to a (not shown) computing device where, based on these images, the respective 3-channel color statistics -21- are calculated.

To illustrate, the 3-dimensional color histogram of the primary decoration and the secondary decoration is shown in FIG. 2 in a graphic depiction in the form of two color clouds -23- and -22- in the joint {RED, GREEN, BLUE} color space -21-. It is easy to see that the color statistics are different: the impregnation and pressing processes caused a positional change of the respective color clouds in the color room.

To a person skilled in the art of image processing it is known that these changes not only cause a positional change of the color cloud (of the so-called scatter diagram) but that the frequencies of the color vector also change.

Since this 4-dimensional representation can no longer be clearly represented in a 2D graphic representation, for reasons of simplification we will forego the graphic representation of the frequencies in the 3D color space -21-, and we will, by way of the indicated color clouds, only graphically show the number of the different color vectors that occur in the color image.

But according to the invention the term “color histogram” implies a 4-dimensional representation; i.e., the determination of the occurring different color vectors in the camera image of the decoration but also the frequency of the occurrence of each color vector.

This change of the primary decoration histogram -22-, hereafter designated as PDH (r,g,b), into the secondary decoration histogram -23-, hereafter designated as SDH(r,g,b) can be mathematically described by a transformation T as follows:

SDH(r,g,b)=T[PDH(r,g,b)] /1/;

and wherein different linear or non-linear functions, for example polynomials, can be used as transformation core.

If SDH(r,g,b) and PHD(r,g,b) are given, for example by at least one evaluated image of the primary decoration and at least one evaluated image of the associated secondary decoration, a transformation rule T with known optimization procedures, which are based, e.g., on the solution of overdetermined systems of equation, can be found. Such solution procedures are, for example, offered under the designation “least square optimization problems” by the mathematical program MATLAB, whereby these mathematical procedures can be presumed to be known to a person skilled in the art, and which is why they do not require further explanation in the context of this description or the invention.

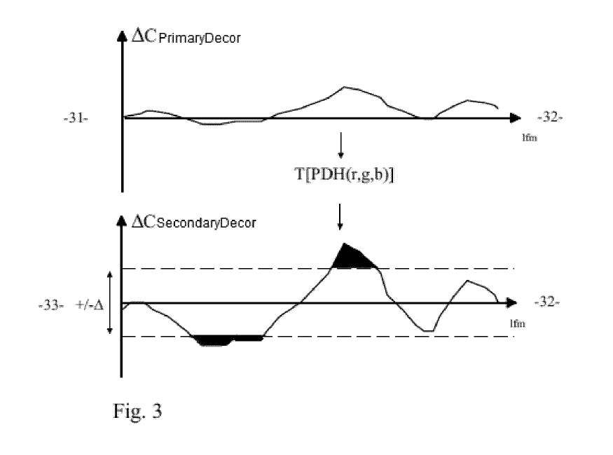

According to the invention, as illustrated in FIG. 3, this transformation T is used as a prediction rule in order to continually convert (predict) the color imprint characteristics, which are measured above the line length lfm, after the printing process of the primary decoration into the corresponding color imprint characteristics of the secondary decoration without waiting for the further process steps such as impregnation and pressing action to occur.

For a simple explanation of the inventive idea, we limit ourselves to the transformation of a single color imprint characteristic, namely the focus point of the 3-dimensional RGB color histogram.

The color imprint of the primary decoration changes if the focus point of the color histogram of the primary decoration changes in comparison to the focus point of color histogram of a reference of the primary decoration.

The scalar amount difference ΔC_{PrimaryDecor} of the focus points is plotted in a graphic format -31- in FIG. 3 of the instantaneous deviation as function of the produced line length -32-. This deviation trend line shows the printer directly the level of stability of his printing process and consequently the level of stability of the color imprint of the primary decoration.

But based on this, the printer is not able to determine the crucial tolerance of the variations of the color imprint of the secondary decoration. Despite continual measuring of the primary decoration, the printer does not have any reliable information regarding the grade and tolerance of the produced end product, which is the secondary decoration.

By the conversion calculation according to the invention of the visual color imprint characteristics after the decorative printing of the primary decoration using the created prediction rules into the visual color imprint characteristics of the secondary decoration of a corresponding graphic display and the comparison of the predicted color imprint characteristics of the secondary decoration with the tolerance values for the secondary decoration the printer is able, however, to recognize immediately, using embodied examples according to the invention, at the location of the primary printing, i.e. without spending time waiting for a laboratory-based impregnation and laboratory-based pressing action of a primary decorative paper sample, if a print is within the tolerances -33- that have been agreed upon with the customer or not.

The printer is now also able to intervene early in a corrective manner in the primary decorative printing and can assess the consequences of the corrective measures relative to the stability of the color imprint of the secondary decoration immediately.

Consequently, upon winning a new production order, the method according to the invention is also able to handle the so-called color matching process considerably faster than this would be possible with the method according to the state of the art that envisions laboratory-based impregnations and pressing action after taking numerous samples.

Naturally, the inventive idea is not limited to the color imprint characteristic “color histogram” and the latter's characteristics such as focus point, variance, etc.; instead it relates to all color imprint characteristics that are relevant for the visual imprint that can be measured based on an n-channel image, such as image definition, contrast sensitivity functions, etc. (see e.g. M. Fairchild: Color Appearance Models, 2nd edition, 2005, John Wiley & Sons Ltd for a list of the so-called CIECAM characteristics for the assessment of the color imprint).

The inventive idea is also not limited to the determination of the color imprint characteristics based on a customary n=3 channel R, G, B-color image. Some of the color imprint characteristics, such as e.g. the image definition, can be obtained from an n=1 channel image, e.g. luminance, others require at least n=3 color channel, others are more favorably measured by so-called hyper-spectral images with n>3 channels. The essential aspect of the inventive idea is the aspect of the prediction of the color imprint of the end product (secondary decoration) by transformation of the color imprint of the primary decoration that is measureable at the printing line using the prediction rule that was created according to the invention, and the display of these predicted color imprint characteristics at the printing line in order to notify the printer early regarding the visual quality of the end product.

The inventive idea comprises all decorated areas and all related suitable decorative procedures, ranging from the classic multiple-color gravure printing or offset printing via digital ink-jet printing and to other decorative methods, such as e.g. spraying, laminating of rolled-out colored plastic material masses, etc.

The method according to the invention is not only useful during the routine production of a decoration, but it is also useful for the set-up process for a new decoration, the so-called process of color matching.

The method according to the invention also allows for measurements to be taken at any location during the process of a decoration for the color imprint characteristics for the so-called primary decoration and convert such characteristics into those that are valid for the secondary decoration. For example, the primary decoration can represent the decoration that was produced by printing technology on neutral decorative paper, and the secondary decoration can represent the decoration after the impregnation.

The essential aspect with regard to the inventive idea is the concept of the creation of prediction rules based on samples of primary and secondary decorations and the application of these prediction rules during the testing phase in order to predict the quality of the secondary decoration early; i.e., that the quality of the secondary decoration is predicted already at the location of the primary decoration.

The method can also be employed in classical magazine, book and packaging print applications, where the printed product is further changed after the completion of the actual multiple-color printing process by additional processes, such as the application of a protective coating, a lacquer finish, embossing, etc. In these applications, the method is limited to elements that are patterned in multiple colors, such as color photos, multi-color textures, etc.; monochrome text elements are faded out.

With the state of the art it was not possible to measure the end quality of the visual color imprint of areas patterned in multiple colors, such as decorative furniture panels, floor laminates, wall paneling, etc., during the essential printing processes of the decoration, the so-called primary decoration, because the subsequent processes, such as impregnation and pressing action, protective lacquer coating, etc., would change the color imprint once more to achieve the secondary decoration. Correspondingly, continual monitoring of the printing process has not been able to date to provide the printer with continual statements regarding the quality of the color imprint of the end product and/or of a color imprint after a further process step that is generated by the printing technology.

The invention envisions that in some preferred embodied examples, during a learning phase for each decoration, prediction rules are generated based on samples of the primary decoration and samples of the secondary decoration in order to determine from n-channel images of samples of the primary decoration color imprint characteristics and to convert them mathematically into those for the secondary decoration (direct prediction); and/or to calculate from n-channel images of samples of the primary decoration images of the secondary decoration and to calculate based on them color imprint characteristics (indirect prediction).

During the testing phase, n-channel images of the primary decoration are continually recorded at the printing line, color imprint characteristics are extracted from them and converted with the assistance of the prediction rules to color imprint characteristics of the secondary decoration, displayed and assigned tolerances.

The method represents a considerable time-saving measure and a means to increase productivity because the deviations from the required final quality of the end product are represented directly during in the context of the printing process, can then be interpreted accordingly by the printer, and thereby allowing for the possibility of the early implementation of suitable counter-measures.

What is claimed is:

1-11. (canceled)

12. A method for monitoring, particularly within a production line, the quality of a visual color imprint of products with patterned, particularly multi colored, surfaces by means of imaging sensors;
wherein, after applying a primary decoration, the products pass through at least one further process step that influences the color imprint before applying a secondary decoration, and wherein the method of monitoring comprises the following two stages:
a) a first stage, particularly for learning a direct prediction and determining direct prediction rules, wherein the first stage comprises the following steps:
a1) scanning suitable samples as a reference for the primary decoration and the second decoration resulting therefrom by means of the imaging sensors;
a2) transmitting image signals of the scanned samples to a computing device;
a3) determining features of the samples from the image signals by means of the computing device and image processing procedures, wherein the features characterize the color imprint of the decoration of the samples;
a4) determining prediction rules by comparing values of the features of the primary decoration and of the secondary decoration, wherein the predication rules transform as precisely as possible the values of the features of the primary decoration into the values of the features of the secondary decoration; and
a5) storing the prediction rules in combination with the corresponding product in a database, particularly as a learning phase for establishing the direct prediction rules;
b) a second stage, particularly for executing the direct prediction during the production of a decoration by applying the prediction rules learned in the first stage, wherein the second stage comprises the following steps:
b1) scanning images of the primary decoration by the imaging sensors, transmitting the images to the computing device, and determining the values of the features of the primary decoration from the images of the primary decoration by the computing device;
b2) calculating predicted values of the features of a secondary decoration by applying the prediction rules corresponding to the secondary decoration to the values of the features of the primary decoration;
b3) displaying the predicted values of the secondary decoration that had been determined for controlling a technical process of the primary decoration, the predicted values being displayed numerically and/or graphically; and/or
b4) comparing the predicted value with prescribed tolerances for the secondary decoration, particularly as a testing phase for checking the production of the primary decoration by direct prediction.

13. A method for monitoring, particularly within a production line, the quality of a visual color imprint of products with patterned, particularly multi colored, surfaces by means of imaging sensors;
wherein, after applying a primary decoration, the products pass through at least one further process step that influences the color imprint before applying a secondary decoration, and wherein the method of monitoring comprises the following two multiple-step stages:
a) a first stage, particularly for learning an indirect prediction and determining indirect prediction rules, wherein the first stage comprises the following steps:
a1) scanning suitable samples as a reference for the primary decoration and the secondary decoration resulting therefrom by means of the imaging sensors;
a2) transmitting image signals of the scanned samples to a computing device;
a3) determining features of the samples from the image signals by means of the computing device and image processing procedures, wherein the features characterize the color imprint of the decoration of the samples;
a4) determining prediction rules based on a comparison of the images of the primary decoration with the associated images of the secondary decoration for calculating predicted images of the secondary decoration from the corresponding images of the primary decoration; and
a5) storing the prediction rules and the features in a database in combination with the corresponding product, particularly as a learning phase for establishing the indirect prediction rules;
b) a second stage, particularly for executing an indirect prediction during the production of a decoration by applying the prediction rules learned in the first stage, wherein the second stage comprises the following steps:
b1) scanning the primary decoration with the imaging sensors, and transmitting the image signals to the computing device;
b2) calculating predicted images of the secondary decoration by means of the prediction rules in the database based on the images of the primary decoration;
b3) determining the features from the predicted images of the secondary decoration for a description of the visual color imprint;
b4) displaying the predicted values of the secondary decoration that had been determined for controlling a technical process of the primary decoration, the predicted values being displayed numerically and/or graphically; and/or
b5) comparing the predicted values with prescribed tolerances for the secondary decoration, particularly as a testing phase for checking the production of the primary decoration by indirect prediction.

14. The method as claimed in claim 12, wherein the prediction rules are specific for each specific interpretation and adjustment of subsequent process steps that change the color imprint of the primary decoration until the secondary decoration is achieved.

15. The method as claimed in claim 12, wherein, during the testing phase, scanning the primary decoration is performed with image sensors installed inside the production line.

16. The method as claimed in claim 12, wherein, during the learning phase, scanning the primary decoration and the secondary decoration is performed with image sensors installed outside of the production line.

17. The method as claimed in claim 12, wherein n-dimensional color statistics and/or features derived therefrom are used as features characterizing the color imprint of the decoration, wherein n represents the number of evaluated spectral channels of the imaging sensors that scan the surface of the product.

18. The method as claimed in claim 12, wherein n-dimensional color statistics and/or features derived therefrom and image sharpness are used as features characterizing the color imprint of the decoration, wherein n represents the number of evaluated spectral channels of the imaging sensors that scan the surface of the product.

19. The method as claimed in claim 12, wherein images of the primary decoration and of the secondary decoration reflect the same image pattern of the decoration.

20. The method as claimed in claim 12, wherein the images of the primary decoration and of the secondary decoration are any color images that are embedded in printed products.

21. An apparatus adapted to perform the method as claimed in claim 12 and/or claim 13, the apparatus comprising:
a computing device;
at least one image converter with n>=2 spectral channels adapted to convert samples of the decoration of multiple-colored patterned products into digital video data, wherein the products are brought automatically or manually into the image field of the image converter under a defined lighting, and to transmit the digital video data to the computing device;
a graphic and/or numerical display device adapted to graphically and/or numerically display data transferred from the computing device; and
a database adapted to store data transferred from the computing device and to provide data queried by the computing device;
wherein:
a) the image converter is configured to convert samples of the primary and the secondary decorations of the products into video data and to transmit the video data to the computing device, during the production and during any other phase, and
b) the computing device is configured to:
extract features from the images, the features characterizing the visually perceived color imprint;
compare the features of the primary decoration and of the secondary decoration with each other and to compute on the basis of said comparison prediction rules adapted to transform the features of the primary decoration into the features of the secondary decoration, particularly as a learning phase for determining the rules for the direct prediction,
store the prediction rules in a database in combination with the corresponding decorated product, particularly as a learning phase for determining the rules for the indirect prediction,
transform the features of the primary decoration into the features of the secondary decoration by means of the prediction rules queried in the database, and to display the predicted values of the secondary decoration overlaid with tolerance fields, which represent the allowable deviations of the color imprint of the secondary decoration, in particular as a testing phase for checking the production of the primary decoration by direct prediction.

22. The apparatus as claimed in claim 21, wherein the apparatus being additionally configured to:
compare the features of the primary and secondary decorations with each other and to compute on the basis of said comparison prediction rules for the calculation of the secondary decoration images from the primary decoration images stored in the database in combination with the corresponding decorated product, particularly as a learning phase for determining the rules for the indirect prediction,
compute by means of the prediction rules stored in the database images of the secondary decoration, and
determine the features of the secondary decoration from the calculated images, to display the features and/or graphically overlay the features with tolerance fields that represent the allowable deviations of the color imprint of the secondary decoration, in particular as a testing phase for checking the production of the primary decoration by indirect prediction.
